(19) United States
(12) Patent Application Publication
(10) Pub. No.: US 2011/0127238 A1
(43) Pub. Date: Jun. 2, 2011

(54) PIPE WELDING PURGE GAS CONTROLLER

(75) Inventor: William Stewart Johnson, McMinnville, OR (US)

(73) Assignee: KINETIC SYSTEMS, INC., Fremont, CA (US)

(21) Appl. No.: 12/952,799

(22) Filed: Nov. 23, 2010

Related U.S. Application Data
(60) Provisional application No. 61/264,752, filed on Nov. 27, 2009.

(51) Int. Cl. B23K 31/00

(52) U.S. Cl. 219/61.5

(57) ABSTRACT

The present invention relates generally to a system and method for welding pipes and controlling the flow of purge gas through the pipes. Purge gas may be remotely controlled by a portable signal input unit.

### CROSS REFERENCE TO RELATED APPLICATIONS

This application claims priority under Section 119 to U.S. Provisional Application Ser. No. 61/264,752 filed on Nov. 27, 2009, the entire disclosure of which is hereby incorporated herein by reference in its entirety for all purposes.

### BACKGROUND OF INVENTION

1. Field of Invention

The present invention relates generally to systems and methods for welding pipes, and more particularly, to a system and method of controlling the flow of a purge gas.

2. Discussion of Related Art

Pipe installation during the fabrication of manufacturing plants, clean rooms, semiconductor and electrical fabrication facilities and the like typically require precision welding of numerous pipe joints positioned either horizontally or vertically. Arc welding is a common method to join abutting pipes in which a power supply produces a low voltage high current source to maintain a stable arc. A typical arc welder, an orbital welder, includes an electrode which revolves around the weld joint to butt weld two pipe ends. Prior to and during welding, a purge gas is passed through the joint to provide a desired weld bead formation, particularly in horizontally positioned pipes.

### SUMMARY OF INVENTION

In accordance with one or more embodiments, the invention relates to a system and method of providing a purge gas to pipe joints to be welded. As is used herein, the phrase “pipe joint to be welded” includes two pipe ends abutting one another in preparation of welding.

In one embodiment, a system for welding pipes comprises a purge gas and a plurality of pipe joints to be welded. A flow controller is fluidly connected downstream of the source of purge gas and upstream of the plurality of pipe joints. A portable sensor detects a characteristic of the purge gas at a first pipe joint of the plurality of pipe joints and a portable signal input unit is connected to the flow controller.

Another embodiment is directed to a method for controlling a purge gas in a welding process comprising passing a purge gas from a source to a mass flow controller and passing the purge gas from the flow controller to a plurality of pipe joints to be welded. A characteristic of the purge gas at a first pipe joint of the plurality of pipe joints to be welded is to measured and a first signal based upon the measured characteristic of the purge gas at the first pipe joint is generated. The method further comprises adjusting the flow of the purge gas from the flow controller based upon the first signal and welding the first pipe joint. The characteristic of the purge gas at a second pipe joint of the plurality of pipe joints to be welded is then measured and a second signal based upon the measured characteristic of the purge gas at the second pipe joint is generated. The flow of the purge gas from the flow controller is adjusted based upon the second signal and the second pipe joint is welded.

Other advantages, novel features and objects of the invention will become apparent from the following detailed description of the invention when considered in conjunction with the accompanying drawing.

### BRIEF DESCRIPTION OF DRAWINGS

The accompanying drawing is not intended to be drawn to scale. For purposes of clarity, not every component may be labeled in every drawing, nor is every component of each embodiment of the invention shown where illustration is not necessary to allow those of ordinary skill in the art to understand the invention. In the drawings:

FIG. 1 is block diagram illustrating a purge system in accordance with one or more embodiments of the invention.

### DETAILED DESCRIPTION

This invention is directed to a system and method of welding pipes. Installation of process piping during the fabrication of manufacturing plants, clean rooms, semiconductor and electrical fabrication facilities and the like typically include numerous welded joints either in series or in parallel. Once a weld has been completed at one of the many joints to be welded, a welder moves to another joint to be welded. However, the flow of purge gas within the system piping may change with the sealing of a single joint. As is commonly known, different weld bead formations result from different levels of purge gas present at the pipe joint to be welded. Undesirable internal pressures of purge gas within the pipe joint may result in a flawed weld bead and subsequent damage to expensive components. Moreover, because the welding area comprises multiple joints to be welded at locations removed from the flow controller, personnel in addition to the welder are often present to adjust the flow to controller according to a welder's verbal instructions. Indeed, in some installations, the overall length of the piping systems may be several hundreds of feet in length. The use of additional personnel and verbal instructions may result in inefficiencies and increased costs during installation.

One embodiment of the present invention comprises a source of purge gas, a flow controller and a portable signal input unit which may be used at any number of pipe joints in a welding zone throughout an installation. Any inert gas that is compatible with the materials of construction may be used. Purge gasses typically include argon, nitrogen, carbon dioxide, helium and mixtures thereof. Any flow controller capable of delivering sufficient quantities of gas to the system and the joints to be welded may be used. Flow may be based upon volume, mass, pressure and combinations thereof. In one embodiment, the flow controller is a mass flow controller.

The portable signal input unit may be constructed and arranged to be carried by a welder as the welder moves from one joint to be welded to another. In one embodiment, the portable signal input unit is a handheld unit. The portable signal input unit may be hard wired or wirelessly connected to the flow controller. For example, the portable signal input unit may be connected to the flow controller by one or more cables, depending upon the distance of the pipe joint to the flow controller. The cable may be of sufficient length to reach all the joints to be welded in the weld zone. Alternatively, cable extensions may be used as the welder works at joints located beyond the length of the original cable. Cable connections offer advantageous over wireless connections in some applications because they do not generate signal interference nor require a line of sight between the flow controller and the portable signal input unit.

Wireless connections suitable to connect the portable signal input unit and the flow controller include infrared and radio frequency connections. In one embodiment, the portable signal input unit communicates with the flow controller via an infrared connection. Wireless connections are advantageous over cable connections in some applications because they are not physically limited by the length of the cable connection.

In one embodiment of the invention, the portable signal input unit may manually or automatically receive input correlating to a detected level of purge gas present at a joint to be welded. For example, a welder may measure the flow of the purge gas at the joint to be welded and manually input information to cause the portable signal input unit to generate a to signal for the flow controller to increase or decrease the flow of purge gas to the system.

Alternatively, the signal input unit may automatically receive a signal from a sensor which measures the flow of the purge gas at the joint to be welded and compare it to a desired value, thereby generating a signal for the flow controller to adjust the flow of purge gas to the system. The flow controller may adjust the flow of the purge gas to the entire weld zone without significant ramification, as the welder may be working at only one joint at a time and making purge gas flow adjustments specific to that joint.

In another embodiment, the system may include a portable sensor to determine the level of purge gas present at each joint to be welded. Any sensor which can detect the desired characteristic of the purge gas may be used. For example, the sensor may be a pressure sensor or flow sensor. The sensor may automatically provide input to the portable signal input unit. Alternatively, the sensor may provide a visual reading to the welder so that the welder may manually input the appropriate data into the portable signal input unit. According to certain embodiments, one or more variables may be measured which may be translated into an input for the flow controller such that the welder may remotely control the internal pressure at a weld zone.

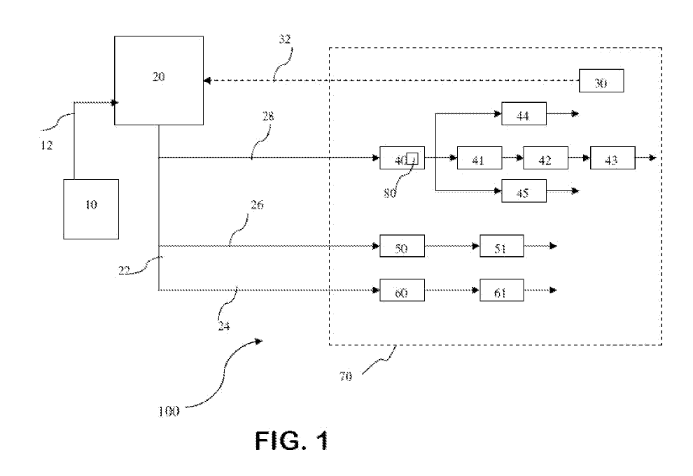

System 100 of FIG. 1 illustrates one embodiment of the present invention. In FIG. 1 a source of purge gas 10 is fluidly connected via line 12 to a mass flow controller 20. Portable signal input unit 30 provides a signal to mass flow controller 20 via signal line 32 which may be wire-based or wireless-based. Flow controller 20 is fluidly connected to pipe joints 40, 50 and 60 to be welded located in weld zone 70 via lines 22, 24, 26, 28. Additional pipe joints to be welded 41, 42, 43 are positioned in series downstream of pipe joint 40. Pipe joints 44 and 45 to be welded are positioned downstream of pipe joint 40 and in parallel to pipe joint 41. Similarly, pipe joint to be welded 51 is positioned downstream of pipe joint 50 and pipe joint to be welded 61 is positioned downstream of pipe joint 60. It is understood that the location of the pipe joints to be welded is dependent upon the desired layout of the installation and that the layout shown in FIG. 1 is merely illustrative of pipe joints in series and in parallel. Additionally, valves such as manual valves, pneumatic valves, solenoid valves, etc. (not shown) may also be included as desired. For example, a shut off valve (not shown) may be positioned upon each of lines 24, 26, and 28 to completely interrupt flow to a particular portion of piping within the weld zone.

During operation, a welder may elect to first weld pipe joint 40. Once the welder has to decided which pipe joint is to be welded, the welder determines the amount of purge gas flowing at that joint via sensor 80. In one embodiment, a pressure sensor is used to determine the level of purge gas flowing at the joint and provides a visual indicator to be read by the welder. The welder may then input data into the portable input signal unit causing the flow controller to adjust flow of the purge gas to a desired level. In one embodiment, the portable signal input unit comprises a first keypad which, when pressed, generates a first signal that is communicated to the flow controller via signal line 32 to increase flow of the purge gas; and a second keypad which, when pressed, generates a second signal that is communicated to the flow controller via signal line 32 to decrease the flow of the purge gas. While adjusting the flow of the purge gas to the first pipe joint to be welded 40, the flow of purge gas to the remaining pipe joints to be welded is similarly affected. Upon a determination that the flow of purge gas has reached a desired level, the welder proceeds to weld pipe joint 40. Upon sealing pipe joint 40, the flow of purge gas to the remaining pipe joints to be welded increases.

The welder then elects to weld any of the remaining pipe joints whether positioned in series or in parallel. In one embodiment, the welder may then choose to work on pipe joint 41 and again determines the current flow of purge gas at that pipe joint via portable sensor 80. The welder then inputs appropriate data into the portable signal input unit to adjust the flow of the purge gas from the mass flow controller to a desired level before beginning to weld. The welder continues to move among the remaining joints to be welded (42,43,44,54,51,61) manually adjusting the flow of purge gas while at the joint to be welded.

As such, the welder moves from pipe joint to pipe joint efficiently adjusting the flow of purge gas without the aid of additional personnel. The welder may also monitor the bead formation and adjust the flow of purge gas as necessary during the welding step.

In accordance with one or more embodiments, an optimum range of pressure values may be based on various parameters including, but not limited to, line size, individual characteristics of a weld program, calibration of welding equipment and metallurgy of the tubing. While some aspects may involve automation, adjustment by an operator may also be required. In at least some embodiments, the controller may modulate flow but not pressure. The pressure value at any given point in an assembly of tubes may be dependent upon various parameters including, but not limited to, gas flow, dynamic conditions (footage, number of to fittings and bends, number of valves and their flow characteristics) between the flow controller and the weld zone, and the amount of restriction at the purge gas outlet from the tube assembly being welded.

In accordance with one or more embodiments, a sensor may include a compression tee, such as a bored-through compression tee with nylon ferrules, and a branch port connected to a low-pressure gage, such as a Mag-Gage™ magnetic liquid level gage commercially available from Process Level Technology, Ltd (League City, Tex.) calibrated in inches of water-column An operator may offset the tube ends at the weld to allow the tee to slide over one tube, then align the tube ends and slides the body of the tee back so that it is centered on the joint. The operator may then read the pressure value at the joint and adjust the flow to get the desired pressure at the joint. Once the flow is set, the operator may remove the tee, realign the tubes and place the weld head over the joint. In some embodiments, the liquid level gage may be replaced with a pressure transducer in communication with the controller. The welder may still input a desired pressure in these embodiments. Such embodiments may involve a small programmable logic controller (PLC) to facilitate the communication between the controller and the transducer.

Having thus described several aspects of at least one embodiment of this invention, it is to be appreciated various alterations, modifications, and improvements will readily occur to those skilled in the art. Such alterations, modifications, and improvements are intended to be part of this disclosure, and are intended to be within the spirit and scope of the invention. Accordingly, the foregoing description and drawings are by way of example only.

This invention is not limited in its application to the details of construction and the arrangement of components set forth in the following description or illustrated in the drawings. The invention is capable of other embodiments and of being practiced or of being carried out in various ways. Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

What is claimed is:

1. A system for welding pipes comprising:
a source of purge gas;
a plurality of pipe joints to be welded fluidly connected to the source of gas;
a flow controller fluidly connected downstream of the source of gas and upstream of the plurality of pipe joints to be welded;
a portable sensor capable of detecting a characteristic of the purge gas at a first pipe joint of the plurality of pipe joints to be welded; and
a portable signal input unit connected to the flow controller.

2. The system of claim 1, wherein the portable signal input unit is a remote manual signal input unit.

3. The system of claim 1, wherein the flow controller is a mass flow controller.

4. The system of claim 2, wherein the signal input unit is connected to the flow controller via a connection selected from the group consisting of: a cable connection and a wireless connection.

5. The system of claim 4, wherein the wireless connection is a connection selected from the group consisting of: an infrared connection and a radio frequency connection.

6. The system of claim 4, wherein the wireless connection is an infrared connection.

7. The system of claim 1, wherein the portable sensor measure any of pressure, mass flow, volume flow; and combinations thereof.

8. A method for controlling a purge gas pressure in a welding process comprising:
passing a purge gas to a mass flow controller;
passing the purge gas from the flow controller to a plurality of pipe joints to be welded;
measuring a characteristic of the purge gas at a first pipe joint of the plurality of pipe joints to be welded;
generating a first signal based upon the measured characteristic of the purge gas at the first pipe joint;
adjusting the flow of the purge gas from the flow controller based upon the first signal;
welding the first pipe joint;
measuring the characteristic of the purge gas at a second pipe joint of the plurality of pipe joints to be welded;
generating a second signal based upon the measured characteristic of the purge gas at the second pipe joint;
adjusting the flow of the purge gas from the flow controller based upon the second signal; and
welding the second pipe joint.

9. The method of claim 8, wherein measuring a characteristic of the purge gas comprises measuring any of mass flow, volume flow, pressure, and combinations thereof.

10. The method of claim 8, wherein adjusting the flow of the purge gas from the flow controller comprises adjusting the flow of purge gas from a mass flow controller.

11. The method of claim 8, further comprising measuring the characteristic of the purge gas at a third pipe joint of the plurality of pipe joints to be welded; generating a third signal based upon the measured characteristic of the purge gas at the third pipe joint; and adjusting the flow of the purge gas from the flow controller based upon the third signal.

12. The method of claim 8, wherein generating the first and second signal comprises manually entering a signal into a remote handheld signal input device.
